(19) United States
(12) Patent Application Publication
(10) Pub. No.: US 2016/0321218 A1
(43) Pub. Date: Nov. 3, 2016

(54) SYSTEM AND METHOD FOR TRANSFORMING IMAGE INFORMATION FOR A TARGET SYSTEM INTERFACE

(71) Applicant: Neatly Co., Denver, CO (US)

(72) Inventors: Matthew Farncombe, Highlands Ranch, CO (US); Mark McCubbin, San Rafael, CA (US); Kyle Printz, San Rafael, CA (US); Stefan Walker, Selston (GB)

(21) Appl. No.: 15/139,553

(22) Filed: Apr. 27, 2016

Related U.S. Application Data
(60) Provisional application No. 62/208,372, filed on Aug. 21, 2015.
(60) Provisional application No. 62/153,344, filed on Apr. 27, 2015.

(51) Int. Cl. G06F 17/22; G06F 17/24; G06F 17/27; G06F 17/21

(52) U.S. Cl. CPC G06F 17/227; G06F 17/218; G06F 17/2241; G06F 17/2247; G06F 17/248; G06F 17/272; G06F 17/274

(57) ABSTRACT

The present disclosure is directed to transforming the style and/or layout information, graphical information associated with a display to be rendered by a target system, into layout and/or position output in a native language of the target system, mapping the data information into data binding output in the native language, the data binding output comprising one or more data binding structures to enable the target system to access the data information from a data source, converting the image information into image information output configured for display by the target system, and providing the style and/or layout output, data binding output, and image information output to the target system.

### CROSS REFERENCE TO RELATED APPLICATION

The present application claims the benefits of U.S. Provisional Application Ser. No. 62/153,344, filed Apr. 27, 2015, entitled “Rapid Access of Backend Data in a Data Intensive Application” and U.S. Provisional Application Ser. No. 62/208,372, filed Aug. 21, 2015, entitled “State Synchronization”, which are incorporated herein by this reference in their entireties.

### FIELD

The disclosure relates generally to image display and particularly to transforming information for display on various devices.

### BACKGROUND

The explosion of smart devices, such as tablet computers, smart phones, laptops, and personal computers, have created issues for a designer, application vendor, and others. Each device can have different graphics rendering languages, which can complicate displaying a given set of images on multiple devices. Currently, a selected graphical image can use native rendering language for some devices and non-native rendering languages for others. For those devices having a different rendering language, displaying the graphical image can be delayed by the need to convert the non-native rendering language by which the received graphical image is expressed into a native rendering language expression of the graphical image.

### SUMMARY

These and other needs are addressed by the various aspects, embodiments, and/or configurations of the present disclosure.

A system can include:

a microprocessor; and

a computer readable medium, in communication with the microprocessor, comprising instructions that program the microprocessor to:

receive graphical information associated with a display to be rendered by one or more target systems, the received graphical information comprising one or more of layout and/or position information, data information, and image information, wherein at least some of the graphical information is in one or more containers comprising an object to be rendered by the target system(s) on a display;

transform the style and/or layout information into layout and/or position output in a native language of the target system(s);

map the data information into data binding output in the native language, the data binding output comprising one or more data binding structures to enable the target system(s) to access the data information from a data source;

convert the image information into image information output configured for display by the target system(s); and

provide the style and/or layout output, data binding output, and image information output to the target system(s).

The native language can be of a client communication device, a server, or a combination thereof. In one application, the layout and/or position output and image information output are expressed in a language native to the client communication device and the data binding output is expressed in a language native to the server. In one application, the layout and/or position output, data binding output, and image information output are all expressed in a language native to the client communication device.

The microprocessor can parse the received style and/or layout information to produce a parse tree having plural nodes and traverses the parse tree to transform the nodes into the native language.

The microprocessor can align and scale the transformed nodes by a grid to form the layout and/or position output, the grid being related to a screen parameter of the display.

The microprocessor can parse the received data information to produce a parse tree having plural nodes and traverses the parse tree to transform the nodes into the native language.

The graphical information can include an identifier associated with the target system to indicate a display parameter of the target system(s).

The converted image information can include an identifier of converted image information provided by the microprocessor previously to the target system(s).

The target system(s) can be a smart phone or tablet computer, such as a smart or tablet computer having an iOS or Android operating system or a derivative thereof.

Each of the style and/or layout, image information output, and data binding output can be in the native language of a common target system, whether a server or communication device. Stated differently, each of the style and/or layout, image information output, and data binding output can be in a common native language.

The received graphical information can be descriptively declared using a domain specific language.

The data binding output can enable late binding, rather than early or static binding, by the target system,

The present disclosure can provide a number of advantages depending on the particular aspect, embodiment, and/or configuration. The system and method of the present disclosure can provide the advantages of native performance, including lower latency, on principal client platforms, such as iOS, Android, and Web, enable rapid iteration that can easily implement basic features and only require custom code for unique feature development on each client platform, or enable easy customization, such as the ability to re-skin and update the flow of the entire application with minimum code. It can enable rapid implementation and deployment of cost effective applications SaaS across multiple verticals, such as practice management and others. As will be appreciated, in any highly data intensive application one of the largest time syncs during development commonly is implementing the various views of the backend data in a backend database. The automated code transformation and generation can minimize developer involvement and enable generic design specifications to be converted into a custom application for a selected type of client platform. The system and method of the present disclosure can render the views beautifully on any selected client platform with the implementation being fully native and custom to each such selected client platform, whether iOS, Android, or Web. While the system and method can support dynamic application changes at runtime, they can output a custom client application with bindings that target efficient runtime performance and optimal download size.

These and other advantages will be apparent from the disclosure.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any computer-readable storage and/or transmission medium that participate in providing instructions to a processor for execution. Such a computer-readable medium can be tangible, non-transitory, and non-transient and take many forms, including but not limited to, non-volatile media, volatile media, and transmission media and includes without limitation random access memory (“RAM”), read only memory (“ROM”), and the like. Non-volatile media includes, for example, NVRAM, or magnetic or optical disks. Volatile media includes dynamic memory, such as main memory. Common forms of computer-readable media include, for example, a floppy disk (including without limitation a Bernoulli cartridge, ZIP drive, and JAZ drive), a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. Computer-readable storage medium commonly excludes transient storage media, particularly electrical, magnetic, electromagnetic, optical, magneto-optical signals.

A “computer readable storage medium” may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may be any computer readable medium that is not a computer readable storage medium and that can communicate, propagate, or transport a program for use by or in connection with an instruction execution system, apparatus, or device. A computer readable signal medium may convey a propagated data signal with computer readable program code embodied therein, for example, in baseband or as part of a carrier wave. Such a propagated signal may take any of a variety of forms, including, but not limited to, electro-magnetic, optical, or any suitable combination thereof. Program code embodied on a computer readable signal medium may be transmitted using any appropriate medium, including but not limited to wireless, wireline, optical fiber cable, RF, etc., or any suitable combination of the foregoing.

A “container” refers to any component that can contain other components inside itself. In some markup languages, such as HTML, the container is the area enclosed by the beginning and ending tags. For example, <HTML >encloses an entire document while other tags may enclose a single word, paragraph, or other elements. In HTML code, all containers must have a start and stop tag to close the container.

“Data mapping” refers to a process of creating data element mappings between two distinct data models. Data mapping can be used as a first step for a wide variety of data integration tasks including: data transformation or data mediation between a data source and a destination, identification of data relationships as part of data lineage analysis, discovery of hidden sensitive data such as the last four digits social security number hidden in another user id as part of a data masking or de-identification project, or consolidation of multiple databases into a single data base and identifying redundant columns of data for consolidation or elimination.

The terms “determine”, “calculate” and “compute,” and variations thereof, as used herein, are used interchangeably and include any type of methodology, process, mathematical operation or technique.

An “image file format” refers to a standardized means of organizing and storing digital images. Image files are composed of digital data in one of these formats that can be rasterized for use on a computer display or printer. An image file format may store data in uncompressed, compressed, or vector formats. Once rasterized, an image becomes a grid of pixels, each of which has a number of bits to designate its color equal to the color depth of the device displaying it. Raster formats include JPEG/JFIF, JPEG 2000, Exif, TIFF, GIF, BMP, PNG, PPM, PGM, PBM, PNM, WEBP, HDR, HEIF, BPG, and other raster and container formats. Vector formats include CGM, Gerber format, SVG, and other 2D or 3D vector formats. Metafile or compound formats are portable formats which can include both raster and vector information. Examples are application-independent formats such as WMF and EMF. The metafile format is commonly an intermediate format.

“Late binding”, or “dynamic binding” is a computer programming mechanism in which the method being called upon an object or the function being called with arguments is looked up by name at runtime. With early binding, or static binding, in an object-oriented language, the compilation phase fixes all types of variables and expressions. This is usually stored in the compiled program as an offset in a virtual method table (“v-table”) and can be very efficient. With late binding the compiler does not have enough information to verify that the method even exists let alone to bind to its particular slot on the v-table. Instead the method is looked up by name at runtime. The primary advantage of using late binding in Component Object Model (COM) programming is that it does not require the compiler to reference the libraries that contain the object at compile time.

The term “means” as used herein shall be given its broadest possible interpretation in accordance with 35 U.S.C., Section(s) 112(f) and/or 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “module” as used herein refers to any known or later developed hardware, software, firmware, artificial intelligence, fuzzy logic, or combination of hardware and software that is capable of performing the functionality associated with that element.

A “native application” or “native app” is an application program that has been developed for use on a particular platform or device. It is written in native code for that platform or device. Because native apps are written for a specific platform, they can interact with and take advantage of operating system features and other software that is typically installed on that platform. Because a native app is built for a particular device and its operating system, it has the ability to use device-specific hardware and software; that is, the native app can take advantage of the latest technology available on mobile devices such as a global positioning system (GPS) and camera.

“Native code” refers to computer programming (code) that is compiled to run with a particular microprocessor and its set of instructions (e.g., operating system). If the same program were to be run on a computer with a different processor, the code could execute only with software that enables the computer to emulate the original microprocessor. In this case, the program would run in “emulation mode” on the new processor and generally slower than in native mode on the original processor. Native code is different from bytecode (sometimes called interpreted code), a form of code that can be said to run in a virtual machine. The present disclosure uses “native” as referring to code that is compiled to run directly on a particular microprocessor and its set of instructions and not to run in emulation mode.

“Software rendering” refers to a process of generating an image from a model by means of computer software. In the context of computer graphics rendering, software rendering refers to a rendering process that is not dependant upon graphics hardware ASICs, such as a graphics card. The rendering takes place entirely in the CPU or microprocessor.

A “vector-based image” refers to an image created by a vector graphics editor, such as Adobe Illustrator or Corel Draw which is a computer program that allows users to compose, using mathematic equations and geometric primitives (points, lines, and shapes), and edit vectorgraphics images interactively on a computer and save them in one of many popular vectorgraphics formats, such as EPS, PDF, WMF, SVG, or VML. Vector graphics generally uses polygons to represent images in computer graphics. Vector graphics are generally based on vectors, which lead through locations called control points or nodes.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 depicts various transformation system components according to an embodiment of the disclosure;

FIG. 2 depicts various container style and/or layout transformer components according to an embodiment of the disclosure;

FIG. 3 depicts various container data mapper components according to an embodiment of the disclosure;

FIG. 4 depicts a transformation system logic flow diagram according to an embodiment of the disclosure;

FIG. 5 depicts container style and/or layout transformer and data mapper logic flow diagrams according to an embodiment of the disclosure;

FIG. 6 depicts an exemplary code snippet according to an embodiment of the disclosure;

FIG. 7 depicts an exemplary code snippet according to an embodiment of the disclosure; and

FIG. 8 depicts a hardware system for executing instructions for the container style and/or layout transformer, view formatter, and container data mapper according to an embodiment of the disclosure.

### DETAILED DESCRIPTION

A transformation system is provided that transforms image information expressed in a first language, such as a markup language or domain specific language (“DSL”), into multiple native rendering languages of various target systems, such as a server, tablet computer, smart phone, laptop, or personal computer. By using native rendering languages for expressing the images, latency from user activation of an icon to display of the associated content can be substantially eliminated.

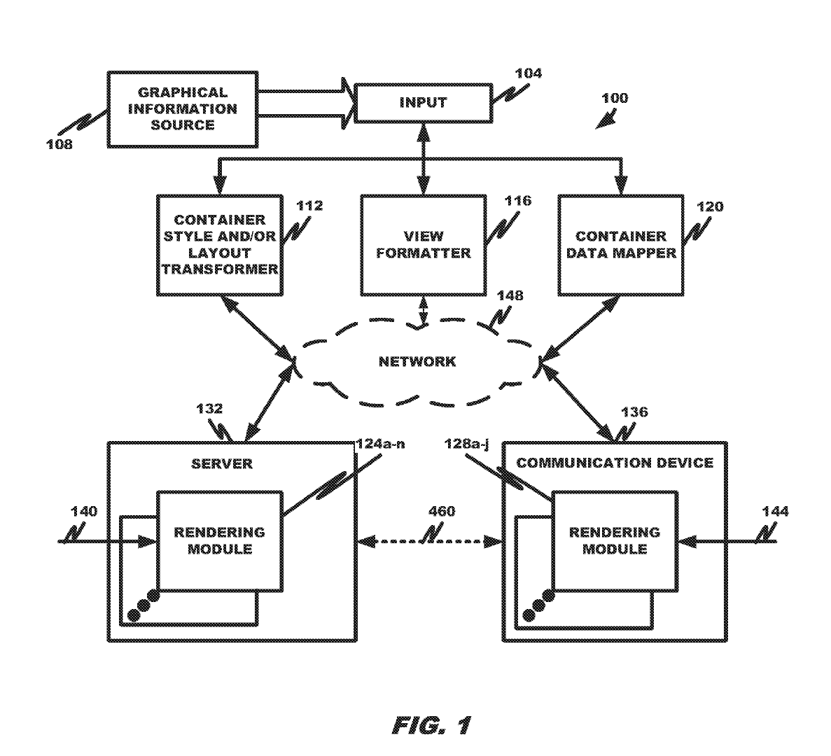

With reference to FIG. 1, the transformation system 100 comprises an input 104 for receiving image information from a source 108 (such as a designer, application vendor, or another source), a container style and/or layout transformer 112 to convert the style and layout container information in the received graphical information into container information having a style and layout compatible with the style and layout capabilities of a target system (e.g., a server that hosts the application programming interface or API that provides a window or access into various services and a datastore or other database), tablet computer, smart phone, laptop, or personal computer) and expressed in a different user interface rendering language of the target system (e.g., a markup language, UIkit™ by Apple™, Travel ProUI kit™, and others), a view formatter 116 to convert the view information in the received graphical information into view information having a format compatible with the format requirements or specifications of a target system and expressed in the different user interface rendering language of the target system, a container data mapper 120 to convert the data elements in the container into data structure descriptors compatible with the requirements of the target system and expressed in the different user interface rendering language of the target system, and one or more rendering modules 124a-n and 128a-j in each of the server 132 and communication device 136, respectively, that provides an appropriate template or structure to combine or merge the outputs (collectively denoted by arrows 140 and 144) of the container style and/or layout transformer 112, view formatter 116, and container data mapper 120 into a common graphical user interface for display by the target system.

These elements are further described below.

The container style and/or layout transformer 112, view formatter 116, container data mapper 120 and rendering modules may be interconnected by an optional network 148. The network 148 can be any distributed processing network used to communicate information between two or more computer systems. A network 148 can communicate in any protocol or format. The network 148 can be an intranet, the Internet, the World Wide Web, etc. It will be appreciated that in various embodiments, the container style and/or layout transformer 112, view formatter 116, container data mapper 120 may communicate with one or more of the rendering modules, communication device 136, or server 132 in the absence of a network 148.

While the target system(s) are depicted by the server 132 and communication device 136 (e.g., a tablet computer, smart phone, laptop, personal computer, or other computing device), it is to be appreciated that any number and types of target systems may receive the outputs 140 or 144 for display to a user.

The container style and/or layout transformer 112, view formatter 116, container data mapper 120 and rendering modules can be instructions recorded on a computer readable medium and executed by a common microprocessor on a common computational system or by multiple microprocessors on different computational systems. Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

### The Container Style and/or Layout Transformer 112

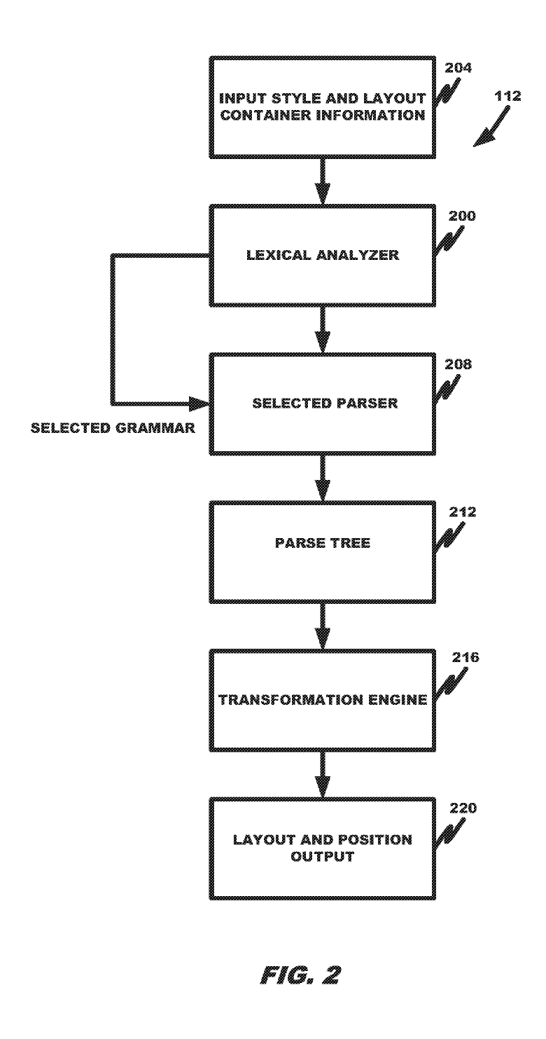

The container style and/or layout transformer 112 shown in FIG. 2 has various components that process the input style and layout information 204 for containers in the received image information. As used herein, “input style and layout information” includes, for example, character set, (e.g., UTF-8), container type or family (e.g., icon, avatar, message, etc.), container size, container position in the view, container alignment, container color information, container width, container height, container float, container margin, container border (e.g., radius, width, style, and color), container padding (e.g., left and right), and other container style or layout variables.

A lexical analyzer 200 analyzes the received input style and layout information 204 to determine a grammar to be used to perform lexical analysis and, applying the determined grammar, generates tokens by which the input character stream is split into meaningful symbols defined by a grammar of regular expressions. The lexical analyzer can apply rules that insert characters indicating a start of a new token.

A parser is selected that corresponds to the determined grammar. As will be appreciated multiple parsers correspond to multiple possible grammars with each parser corresponding to a different grammar.

The selected parser 208 parses or syntactically analyzes the output of the lexical analyzer 200 and outputs a parse tree 212. In some applications, the selected parser checks that the tokens form an allowable expression. This can be done with reference to a context-free grammar, which recursively defines components that can make up an expression and the order in which they must appear. However, not all rules defining programming languages can be expressed by context-free grammars alone, for example type validity and proper declaration of identifiers. These rules can be formally expressed with attribute grammars.

The transformation engine 216 semantically parses, or traverses the parse tree, to convert the parse tree into layout and position output 220. For example, the transformation engine 216 can express the parse tree in a rendering language of one or more target system(s).

### View Formatter 116

The image formatter 116 converts the view information in the received image information into view information output having an image file format compatible with the image file format requirements or specifications of one or more target system(s). Stated differently, the view formatter 116 takes as input vector-based and/or regular images and preprocesses them to a native target system format, such as PNG, Fonts, and Vectors. For example, the view formatter 116 can convert a view from a first image file format or component thereof (e.g., resolution) to a different second image file format or component thereof for the target system(s).

### Container Data Mapper 120

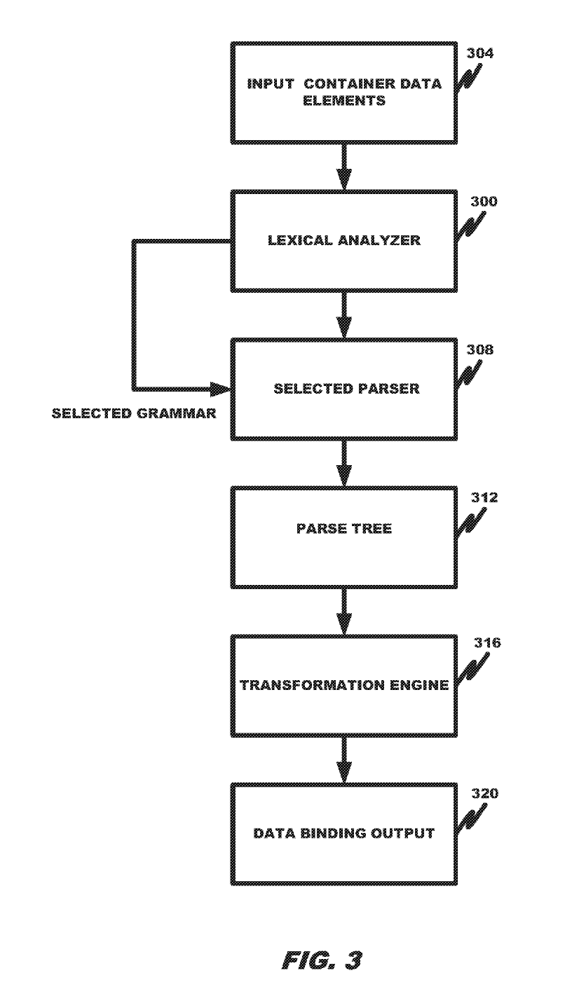

The container data mapper 120 shown in FIG. 3 has various components that process the data information in containers in the received image information. As used herein, “data information” includes, for example, data structures contained in a database or other computer readable medium. Examples of data structures include message content, records, data files, or other information stored as bits and bytes in a computer readable medium. By way of illustration, the container data mapper 120 takes the input 104 that specifies what data should be used in any given visual element or container and outputs correctly target system mappings for the data. The container data mapper 120 can be a compiler that receives input 104 and constructs the necessary backend bindings for an application program interface that exposes correctly all data to one or more client applications executing on the target system. The container data mapper 120 can bind data structures at runtime (e.g., late binding); however, the container data mapper 120 ensures that all data and flow defined for an application both exist and are connected correctly (e.g., there are no dead ends causing processing faults or errors).

A lexical analyzer 300 analyzes the received input container data elements 304 to determine a grammar to be used to perform lexical analysis and, applying the determined grammar, generates tokens by which the input character stream is split into meaningful symbols defined by a grammar of regular expressions. The lexical analyzer can apply rules that insert characters indicating a start of a new token.

A parser is selected that corresponds to the determined grammar. As will be appreciated multiple parsers correspond to multiple possible grammars with each parser corresponding to a different grammar.

The selected parser 308 parses or syntactically analyzes the output of the lexical analyzer 300 and outputs a parse tree 312. In some applications, the selected parser checks that the tokens form an allowable expression. This can be done with reference to a context-free grammar, which recursively defines components that can make up an expression and the order in which they must appear. However, not all rules defining programming languages can be expressed by context-free grammars alone, for example type validity and proper declaration of identifiers. These rules can be formally expressed with attribute grammars.

The transformation engine 316 semantically parses, or traverses the parse tree, to convert the parse tree into data binding output 320. For example, the transformation engine 316 can express the parse tree in a rendering language of one or more target system(s). The data binding output 320 expresses data elements in the containers in the target rendering language of the target system(s) using data binding structures, such as addresses, links, hash functions, or other descriptions of where and/or how to locate the data elements that enable the target system to locate quickly the data elements in a host or source location in a computer readable medium. A “data element” can be any data information component, including a data structure.

### The Rendering Module 124 and 128

The rendering modules 124a-n and 128a-j receive the input 140 and 144, respectively, which correlates to the layout and position output 220, view information output, and data binding output 320, and provides a template, scaffold, or other pattern or renderer for reference for merging the containers in the layout and position output 220 and data binding output 320 and view information output into a common display by the target system(s). The template can be, for example, a suite or collection of templates with dynamic data binding that allows full reuse and instances in any form. The template can be view output of the view formatter 116 that is stored as a template for current and later use. A target system can have only one rendering module 124 or 128 received as part of the input 140 or 144 or multiple rendering modules 124 or 128, depending on the application. Where the target system has multiple rendering modules 124 or 128, each of the rendering modules can have a unique identifier that is included in the input 140 to notify the microprocessor of the target system which rendering module 124 or 128 is to be used to merge the input 140 or 144. In one application, the rendering module(s) 124a-n in the server 132 is scaffolding, such as one or more of node JS scaffolding or Rails scaffolding, and the rendering module(s) 128a-j in the communication device 136 is one or more of an iOS renderer, Web renderer, Android renderer, and floating topic renderer. The scaffolding and renderer are native to the server and communication device, respectively.

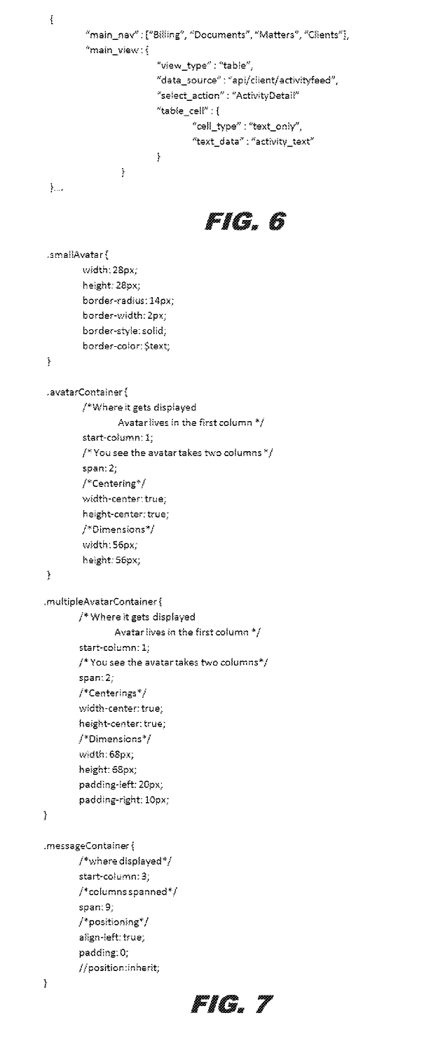

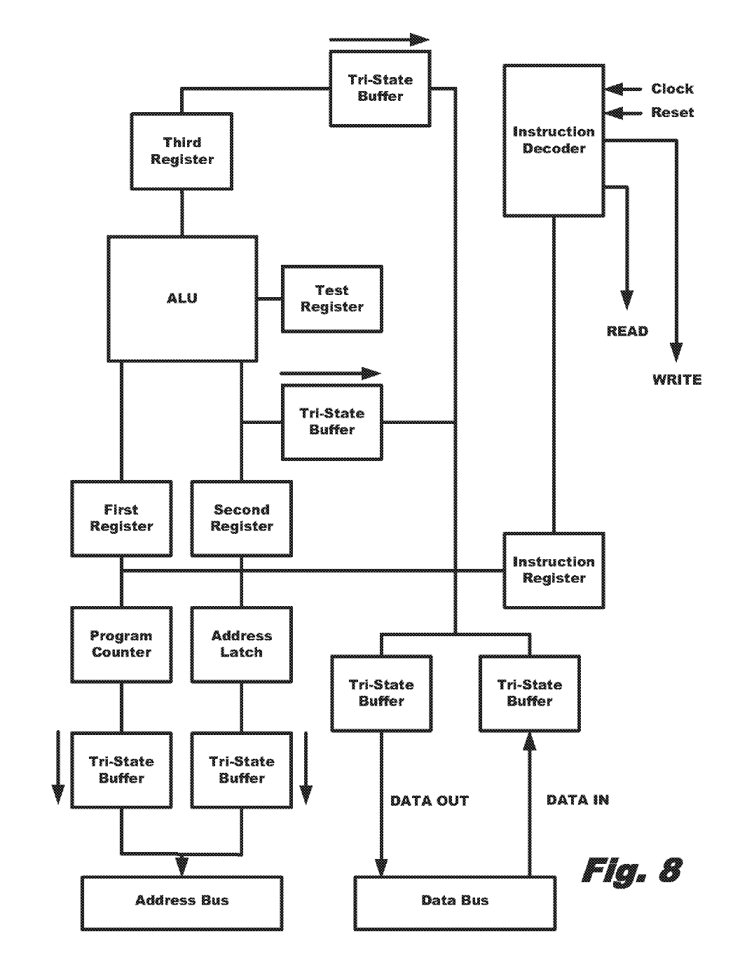

The container style and/or layout transformer 112, view formatter 116, and container data mapper 120 can receive a common or different input 104 depending on the application. Code snippet examples of common input 104 are shown in FIGS. 6 and 7. As can be seen from FIG. 6, the input 104 can be descriptively declared using a Domain Specific Language (“DSL”) that enables not only description of the entire flow of an application in a concise JavaScript Object Notation (“JSON”) format but also describes what data from a background application program interface is necessary to render visual components or containers for each customer view in an application. As will be appreciated, a DSL is a computer language, such as HTML, specialized to a particular application domain. DSLs can be further subdivided by the kind of language, and include domain-specific markup languages, domain-specific modeling languages (more generally, specification languages), and domain-specific programming languages. JSON is an open-standard format that uses human-readable text to transmit data objects consisting of attribute—value pairs. As can be further seen from FIG. 7, the inputs provide customer properties for managing a responsive grid layout more easily transformed for embedded platforms and web applications.

The container style and/or layout transformer 112, view formatter 116, and container data mapper 120 can execute in parallel or serially in a pipelined configuration. As will be appreciated, a pipeline is a set of data processing elements connected in series, where the output of one element is the input of the next one. The elements of a pipeline are often executed in parallel or in time-sliced fashion; in that case, some amount of buffer storage is often inserted between elements. They can execute on a common microprocessor in a multithreaded configuration or different microprocessors. As will be appreciated, a thread of execution is the smallest sequence of programmed instructions that can be managed independently by a scheduler, which is typically a part of the operating system. The implementation of threads and processes differs between operating systems, but in most cases a thread is a component of a process. Multiple threads can exist within one process, executing concurrently (one starting before others finish) and share resources such as memory, while different processes do not share these resources. In particular, the threads of a process share its instructions (executable code) and its context (the values of its variables at any given time).

Where the container style and/or layout transformer 112, view formatter 116, and container data mapper 120 execute concurrently and not sequentially, synchronizing the layout and position output 220, view information output, and data binding output 320 with one another and to a common set of input 104 information can be done using an identifier and/or timestamp. The identifier can be a database storage location or address, packet sequence or identification number associated with transmission or receipt of the input 104, counter, or other identifier to correlate the layout and position output 220, view information output, and data binding output 320 with a common set of input 104 information. Alternatively or additionally, a timestamp, such as a timestamp of recording of a selected item of the input information 104 in a database, transmission of a selected item of the input information 104, or receipt of the selected item of the input information 104 can be employed. The identifier can be exchanged to determine or detect comparative latency in receipt of output by the server and communication device.

In the various embodiments of the disclosure, the particular arrangement and data flow through the optional network 148, or in the absence of the network 148, can take many forms for a variety of purposes (e.g., locating substantial amounts of data processing and storage on a server 132, minimizing the amount of data that is transmitted to the communication device 136, etc.). In an exemplary embodiment, the container style and/or layout transformer 112 and the view formatter 116 communicate directly with the communication device 136 while the data mapper 120 communicates through the network 148 with the server 132, and then the server 132 communicates with the communication device 136. In this arrangement, the container style and/or layout transformer 112 sends the layout and position output 220, which is translated from the input DSL to the chosen native rendering language of the communication device 136, to the communication device 136. Further, the view formatter 116 sends the transformed image assets or image information output, which is also translated from the input DSL to the chosen native rendering language of the communication device 136, for display in or in association with the layout and position output 220 to the communication device 136. Simultaneously, the data mapper 120 sends data information to the server 132, which stores and processes the data information using an API to then generate a data binding output 320. The data binding output 320 can be in the native rendering language of either the server or communication device. The communication device 136 can have a bi-directional communication, via link 160, with the server 132, and therefore, the communication device 136 receives the necessary data binding output 320 to populate containers in the layout and position output 220 on the communication device 136, which combines all three outputs in the native rendering language for display on the communication device 136.

The bi-directional communication in this embodiment allows for the communication device 136 to send data to the server 132. Therefore, if a user manipulates data on the communication device 136, for example, a mobile phone, then the communication device 136 can send the relevant data updates to the sever 132, and the server 132 maintains an authoritative copy of the data information. If there are conflicts between the data on the communication device 136 and the data on the server 132, a hierarchical system may be utilized to resolve conflicts. In one embodiment, changes to data on the communication device 136 are tracked using a time stamp and are tagged with meta data that indicates whether the change in data is a critical state change (immutable), a non-critical update (potentially mergable), or a new object altogether. Conflict resolutions such as destructive removals, additions, and object replacement will occur on the server 132 depending on the tagged meta data. Further, the changes will occur in the order they are received by the server 132.

It will be appreciated that there are other arrangements and data flows through the optional network 148. In another embodiment, the container style and/or layout transformer 112, the view formatter 116, and the data mapper 120 all communicate through the network 148 with the server 132, and then the server 132 communicates with the communication device 136. Thus, the combination of the three outputs in a native rendering language is performed on the server 132. The native rendering language can be native to the server or communication device depending on the application. Then, the server 132 transmits the combined outputs in the native rendering language to the communication device 136.

Likewise, the container style and/or layout transformer 112, the view formatter 116, and the data mapper 120 may all communicate directly with the communication device 136 itself, without any intermediate server 132 or network 148. Therefore, the three outputs described above are combined on the communication device 136 in the native rendering language of the computational device for display on the communication device 136.

In yet another embodiment, the view formatter 116 pulls the image assets in the received graphical information from a remote server and sends the transformed image assets, expressed in a language native to the communication device and/or server, to the server 132 where bidirectional communication with the communication device 136 is possible. This may be advantageous when, for example, the user wants to manipulate the image assets that are rendered on the display of the communication device 136. In this case, the communication device 136 can send the changes to the image assets to the server 132 where the server 132 maintains an authoritative version of the image assets.

### Logic Flows for Container Style and/or Layout Transformer 112,

### View Formatter 116, and Container Data Mapper 120

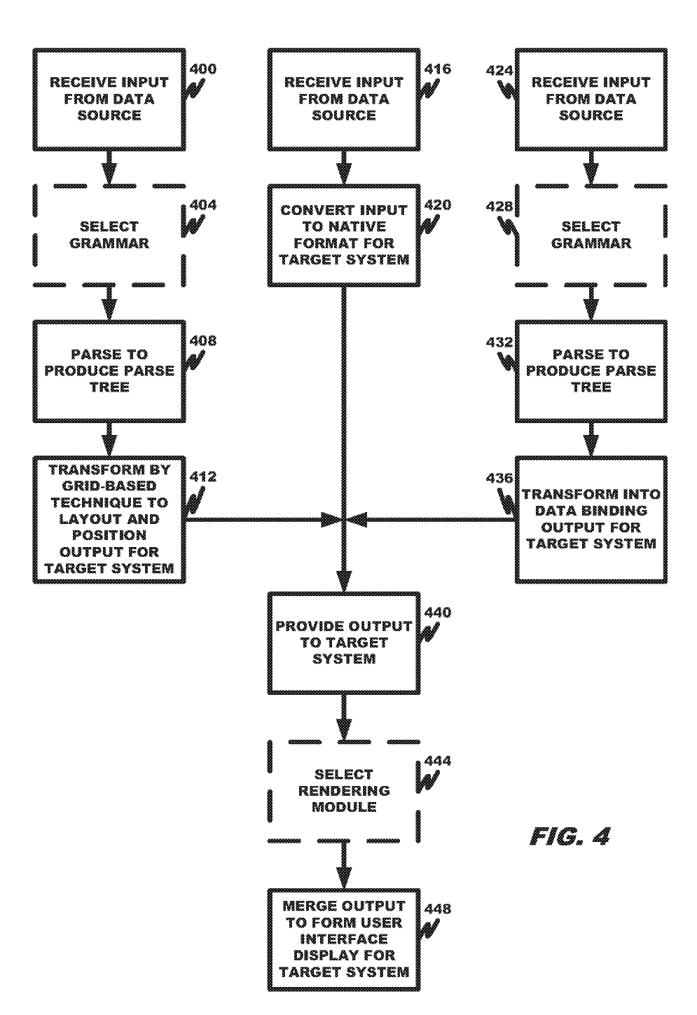

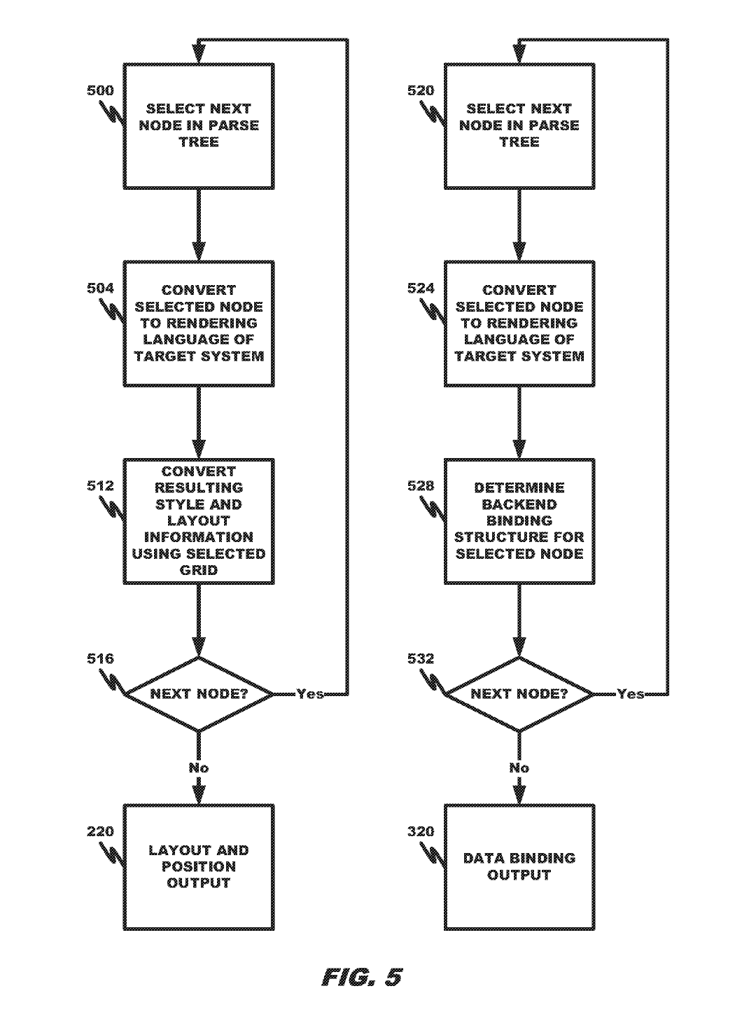

The operations of the container style and/or layout transformer 112, view formatter 116, and container data mapper 120 will now be discussed with reference to FIGS. 4 and 5. These operations are typically triggered by or in response to receipt from the communication device by the server of a request for an identified set of graphical information to be displayed by the communication device (e.g., the target system) to a user. In response, the server forwards the request to the transformer system, which requests, from a graphical information source (which may or may not be associated with the server 132), the requested graphical information, which is subsequently received as input by the transformer system.

In step 400, the container style and/or layout transformer 112 receives the input 104 from a graphical information source 108.

In step 404, the container style and/or layout transformer 112 preprocesses the input 104 and selects a grammar (or parser) to be employed.

In step 408, the selected parser parses the input 104 to produce a parse tree comprising nodes, each node corresponding to parsed style and/or layout information.

In step 412, the container style and/or layout transformer 112 traverses the parse tree, node-by-node, as will be further illustrated by FIG. 5.

In step 500, the container style and/or layout transformer 112 selects a next node in the parse tree.

In step 504, the container style and/or layout transformer 112 converts the selected node to the rendering language of the target system.

In step 512, the container style and/or layout transformer 112 converts the resulting style and layout information using a selected grid that is indexed to a display or screen size of the target system. The grid, which can include one or more nested grids, can provide consistent alignment and scalability between target system screen form factors. A “screen form factor” typically refers to the size, shape, and style, layout and/or position of one or more screen components, such as the display area. It can perform a custom transformation of the input style and layout information to produce correct results for the target system. Generally, each screen form factor has a corresponding grid. Typically, the grids for a server and communication device are different and for different types of communication devices are different. Accordingly, the container style and/or layout transformer 112 uses an identifier or indicator of the type of target system or screen form factor of the target system to select the appropriate grid from among plural possible grids to be employed.

In decision diamond 516, the container style and/or layout transformer 112 determines whether or not there is a next node in the parse tree. If so, the container style and/or layout transformer 112 returns to step 500 and, if not, outputs the layout and position output 220.

Returning to FIG. 4, the view formatter 116, in step 416, receives input 104 and, in step 420, converts the input to a native format for the target system to provide view information output. The view information output can be an identifier of a rendering module 124 or 128 to be employed in merging the layout and position output and data binding output.

In step 424, the container data mapper 112 receives the input 104 from the graphical information source 108.

In step 428, the container data mapper 112 preprocesses the input 104 and selects a grammar (or parser) to be employed.

In step 432, the selected parser parses the input 104 to produce a parse tree comprising multiple nodes, each node corresponding to parsed data information.

In step 436, the container data mapper 112 traverses the parse tree node-by-node, as will be further illustrated by FIG. 5.

In step 520, the container data mapper 112 selects a next node in the parse tree.

In step 524, the container data mapper 112 converts the selected node to the rendering language of the target system or the server depending on the application.

In step 528, the container data mapper 112 determines the backend binding for the selected node.

In decision diamond 532, the container data mapper 112 determines whether or not there is a next node in the parse tree. If so, the container data mapper 112 returns to step 520 and, if not, outputs the data binding output 320.

Returning to step 440 of FIG. 4, the container style and/or layout transformer 112, view formatter 116, and container data mapper 120 provide respective output to the target system (and/or server).

In optional step 444, the target system, when a rendering module identifier is provided by the view formatter selects a rendering module to be used in merging the layout and position output 220 and data binding output 320.

In step 448, the target system, using the rendering module, merges the layout and position output 220 and data binding output 320 to form a user interface display for the target system.

A further example of a common input 104 is shown in Appendix A of the attached Appendices, which are incorporated herein by this reference in their entireties. This common input 104 is declared using a DSL, and the information in the common input 104 is fed into the container style and/or layout transformer 112, view formatter 116, and container data mapper 120. At the other end of the logic flow, steps 440, 444, 448 translate the outputs of the container style and/or layout transformer 112, view formatter 116, and container data mapper 120 into native rendering languages for various devices. For example, Appendix B shows the particular JSON format that allows for native rendering on mobile iOS devices. In addition, Appendices C and D show the CSS and HTML formats, respectively, that allow for native rendering on the web. The native rendering languages in Appendices B-D are exemplary, and it will be appreciated that embodiments of the disclosure can accommodate any native rendering language that currently exists or will exist in the future.

With reference to FIG. 8, the container style and/or layout transformer 112, view formatter 116, and/or container data mapper 120 can be executed by the arithmetic/logic unit (“ALU”), which performs mathematical operations, such as addition, subtraction, multiplication, and division, machine instructions, an address bus (that sends an address to memory), a data bus (that can send data to memory or receive data from memory), a read and write line to tell the memory whether to set or get the addressed location, a clock line that enables a clock pulse to sequence the processor, and a reset line that resets the program counter to zero or another value and restarts execution. The arithmetic/logic unit can be a floating point processor that performs operations on floating point numbers. The arithmetic/logic unit is in communication with first, second, and third registers that are typically configured from flip-flops, an address latch, a program counter (which can increment by “1” and reset to “0”), a test register to hold values from comparisons performed in the arithmetic/logic unit (such as comparisons of any of the identifiers referenced above), plural tri-state buffers to pass a “1” or “0” or disconnect its output (thereby allowing multiple outputs to connect to a wire but only one of them to actually drive a “1” or “0” into the line), and an instruction register and decoder to control other components. Control lines from the instruction decoder can: command the first register to latch the value currently on the data bus, command the second register to latch the value currently on the data bus, command the third register to latch the value currently output by the ALU, command the program counter register to latch the value currently on the data bus, command the address register to latch the value currently on the data bus, command the instruction register to latch the value currently on the data bus, command the program counter to increment, command the program counter to reset to zero, activate any of the plural tri-state buffers (plural separate lines), command the ALU what operation to perform, command the test register to latch the ALU's test bits, activate the read line, and activate the write line. Bits from the test register and clock line as well as the bits from the instruction register come into the instruction decoder. The ALU executes instructions for the container style and/or layout transformer 112, view formatter 116, and/or container data mapper 120.

Any of the steps, functions, and operations discussed herein can be performed continuously and automatically.

The exemplary systems and methods of this disclosure have been described in relation to a distributed processing network. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a server, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system, comprising:
a microprocessor; and
a computer readable medium, in communication with the microprocessor, comprising instructions that program the microprocessor to:
receive graphical information associated with a display to be rendered by one or more target systems, the received graphical information comprising one or more of layout and/or position information, data information, and image information, wherein at least some of the graphical information is in one or more containers comprising an object to be rendered by the one or more target systems on a display;
transform the style and/or layout information into layout and/or position output in a native language of the one or more target systems;
map the data information into data binding output in the native language, the data binding output comprising one or more data binding structures to enable the one or more target systems to access the data information from a data source;
convert the image information into image information output configured for display by the one or more target systems; and
provide the style and/or layout output, data binding output, and image information output to the one or more target systems.

2. The system of claim 1, wherein the microprocessor parses the received style and/or layout information to produce a parse tree having plural nodes and traverses the parse tree to transform the nodes into the native language.

3. The system of claim 2, wherein the microprocessor aligns and scales the transformed nodes by a grid to form the layout and/or position output, the grid being related to a screen parameter of the display.

4. The system of claim 1, wherein the microprocessor parses the received data information to produce a parse tree having plural nodes and traverses the parse tree to transform the nodes into the native language.

5. The system of claim 1, wherein the graphical information comprises an identifier associated with the one or more target systems to indicate a display parameter of the one or more target systems.

6. The system of claim 1, wherein the converted image information comprises an identifier of converted image information provided by the microprocessor previously to the one or more target systems.

7. The system of claim 1, wherein the one or more target systems is a smart phone or tablet computer, wherein each of the layout and/or position output, data binding output, and image information output is received by and in a native language of a common target system, wherein the received graphical information is descriptively declared using a domain specific language, wherein the data binding output enables late binding by the one or more target systems, and wherein the one or more target systems has an iOS or Android operating system or a derivative thereof.

8. A method, comprising:
receiving, by a microprocessor, graphical information associated with a display to be rendered by one or more target systems, the received graphical information comprising one or more of layout and/or position information, data information, and image information, wherein at least some of the graphical information is in one or more containers comprising an object to be rendered by the one or more target systems on a display;
transforming, by the microprocessor, the style and/or layout information into layout and/or position output in a native language of the one or more target systems;
mapping, by the microprocessor, the data information into data binding output in the native language, the data binding output comprising one or more data binding structures to enable the one or more target systems to access the data information from a data source;
converting, by the microprocessor, the image information into image information output configured for display by the one or more target systems; and
providing, by the microprocessor, the style and/or layout output, data binding output, and image information output to the one or more target systems.

9. The method of claim 8, wherein, in the transforming step, the microprocessor parses the received style and/or layout information to produce a parse tree having plural nodes and traverses the parse tree to transform the nodes into the native language.

10. The method of claim 9, wherein, in the transforming step, the microprocessor aligns and scales the transformed nodes by a grid to form the layout and/or position output, the grid being related to a screen parameter of the display.

11. The method of claim 8, wherein, in the mapping step, the microprocessor parses the received data information to produce a parse tree having plural nodes and traverses the parse tree to transform the nodes into the native language.

12. The method of claim 8, wherein the graphical information comprises an identifier associated with the target system to indicate a display parameter of the one or more target systems.

13. The method of claim 8, wherein the converted image information comprises an identifier of a converted image information provided by the microprocessor previously to the one or more target systems.

14. The method of claim 8, wherein the one or more target systems is a smart phone or tablet computer, wherein each of the layout and/or position output, data binding output, and image information output is received by a common target system, wherein each of the layout and/or position output, data binding output, and image information output is in a common native language, wherein the received graphical information is descriptively declared using a domain specific language, wherein the data binding output enables late binding by the one or more target systems, and wherein the one or more target systems has an iOS or Android operating system or a derivative thereof.

15. A computer readable medium comprising microprocessor executable instructions that, when executed by the microprocessor, cause the microprocessor to:
receive graphical information associated with a display to be rendered by a target system, the received graphical information comprising one or more of layout and/or position information, data information, and image information, wherein at least some of the graphical information is in one or more containers comprising an object to be rendered by the target system on a display;
transform the style and/or layout information into layout and/or position output in a native language of the target system;
map the data information into data binding output in the native language, the data binding output comprising one or more data binding structures to enable the target system to access the data information from a data source;
convert the image information into image information output configured for display by the target system; and
provide the style and/or layout output, data binding output, and image information output to the target system.

16. The computer readable medium of claim 15, wherein, in the transforming, the microprocessor parses the received style and/or layout information to produce a parse tree having plural nodes and traverses the parse tree to transform the nodes into the native language.

17. The computer readable medium of claim 16, wherein, in the transforming, the microprocessor aligns and scales the transformed nodes by a grid to form the layout and/or position output, the grid being related to a screen parameter of the display.

18. The computer readable medium of claim 15, wherein, in the mapping, the microprocessor parses the received data information to produce a parse tree having plural nodes and traverses the parse tree to transform the nodes into the native language.

19. The computer readable medium of claim 15, wherein the graphical information comprises an identifier associated with the target system to indicate a display parameter of the target system.

20. The computer readable medium of claim 15, wherein the converted image information comprises an identifier of a converted image information provided by the microprocessor previously to the target system.

21. The computer readable medium of claim 15, wherein the target system is a smart phone or tablet computer, wherein each of the layout and/or position output, data binding output, and image information output is received by a common target system, wherein each of the layout and/or position output, data binding output, and image information output is in a native language of the common target system, wherein the received graphical information is descriptively declared using a domain specific language, wherein the data binding output enables late binding by the target system, and wherein the target system has an iOS or Android operating system or a derivative thereof.
